(19) United States
(12) Patent Application Publication
(10) Pub. No.: US 2002/0171650 A1
(43) Pub. Date: Nov. 21, 2002

(54) Apparatus for graphical fleet management

(75) Inventor: Sanjiv Prabhakaran, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Mobile Information Systems, Inc., Sunnyvale, CA

(21) Appl. No.: 09/981,661

(22) Filed: Oct. 17, 2001

Related U.S. Application Data
(63) Continuation of application No. 08/697,825, filed on Aug. 30, 1996, now abandoned.
(63) Continuation of application No. 08/443,062, filed on May 17, 1995, now Pat. No. 5,636,122.
Application No. 08/443,062 is a continuation-in-part of application No. 07/961,736, filed on Oct. 16, 1992, now Pat. No. 5,428,546.
(60) Provisional application No. 60/003,153, filed on Sep. 1, 1995.

(51) Int. Cl. G06T 1/60

(52) U.S. Cl. 345/530

(57) ABSTRACT

A computer system including a display coupled to a positioning system, for forming an output display, includes a display manager coupled to the display for displaying an image of a particular geographic area on the display, a raster map database including images of a geographic area, a raster map loader coupled to the raster map database and to the display manager for retrieving the image of the particular geographic area from the raster map database, an icon manager coupled to the display for displaying icons on the display, a data manager coupled to the display for displaying vehicle data and vector data on the display, and a distributor coupled to the icon manager, to the data manager, and to the positioning system, for receiving the vehicle data and the vector data from the positioning system and for updating the data manager and the icon manager.

### CROSS REFERENCE TO RELATED APPLICATIONS

This application is a continuation-in-part of application Ser. No. 08/443,062 filed May 17, 1995 (Attorney Docket No. 15517-000110) and is a continuation-in-part of Provisional Application Serial No. 60/003,153 filed Sep. 1, 1995 (Attorney Docket No. 15517-000140), all in the name of the present assignee. This application is also related to application Ser. No. 08/443,063 filed May 17, 1995 (Attorney Docket No. 15517-000130), in the name of the present assignee. Furthermore, this application is related to application Ser. Nos. ______ , and ______ (Attorney Docket Nos. 15517-000111 and 15517-000142, respectively) filed on the same date of this present application, all in the name of the present assignee. All of these documents are hereby incorporated by reference for all purposes.

### COPYRIGHT NOTICE

A portion of the disclosure of this patent contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates to a method and apparatus for fleet management. More specifically, the present invention relates to an apparatus for graphically tracking the location and status of mobile transmitter units.

In the fleet management business, knowledge of the status and location of a fleet of vehicles, carrying mobile transmitter units, is a powerful tool for a fleet manager and fleet operators. By quickly being able to determine the location of the fleet, the fleet manager is able to make informed and efficient time critical decisions, and fleet operators are able to efficiently determine their position.

Various navigational systems, including the LORAN system, the Global Positioning System (GPS), and others, have been used to determine the locations of vehicles such as ships, airplanes, trucks, etc. in a fleet, typically in terms of longitude and latitude. By installing mobile navigational systems and mobile transmitter units into such vehicles, fleet operators are able to determine their position within a geographic area and the fleet manager is able to receive updated positions of fleet vehicles.

Typical fleet management systems have required the fleet manager to “manage” information between multiple computers and display screens. For example, on a first computer, fleet management software such as computer aided dispatching (CAD) software, provides the fleet manager with information regarding types of fleet vehicles, cargo, operators, and job assignments, job schedules, etc. Next, on a second computer, mapping software provides the fleet manager with a graphic representation illustrating the geographic position of the fleet vehicles. Such a scenario is sufficient for the fleet manager if minor changes, modifications, etc. are needed for the fleet throughout the day, however this is not the typical case. In a more typical situation, the fleet manager has to contend with scheduling changes due to broken-down vehicles, traffic jams, rush jobs, cancellations, etc. Because of these changes, the fleet manager must constantly refer back-and-forth between screens in order to dynamically manage the fleet, for example re-assigning jobs, re-routing vehicles, adding jobs, etc.

FIG. 1 illustrates one of the first fleet management systems that provided enhanced graphical displays to the fleet manager. FIG. 1 includes a fleet management system 10 including a mobile position block 20, a display system 30, and a fleet mobile data suite 40. Display system 30 includes a raster map database 50, a raster utility library 60, a vector database 70, a vector utility library 80, a mobile information data process (MID) 90, a Fleet Process 100, and a display 110.

In operation, positional information of fleet vehicles is first obtained from fleet mobile data suite 40. Typically fleet mobile data suite 40 includes a plurality of fleet vehicles, each including a navigational system, such as GPS, in addition to a radio transceiver for sending (and receiving) data to mobile position block 20. In response to the data, mobile position block 20 processes the data, identifies the vehicles corresponding to the data, and passes the data to display system 30.

Upon receipt of the data from mobile position block 20, MID process 90 uses vector utility library 80 to access vector data from vector database 70. Fleet process 100 receives the data from mobile position block 20 and uses raster utility library 60 to retrieve an image of a map from raster map database 50. Fleet process 100 also receives the data from MID process 90, and then displays the map and the vector information of display 110.

FIG. 2 illustrates a typical output display produced by one embodiment of the system in FIG. 1. The image 130 is typically displayed on a raster-scan display screen and includes a map portion 140 and a vector data portion 150. Map portion 140 includes an image of a geographical area, typically from the raster map database, or alternatively a vector map database, and includes a number of icons 160 representing the vehicle locations. Vector data portion 150 includes data from the vector data base including present street location of the vehicle, closest-cross section streets, destination information, etc. As illustrated, vector data portion 150 also includes information regarding the operator, type of vehicle, status, etc. of vehicle in text form.

Map portion 140 and vector data portion 150 may be simultaneously displayed on a display, may be alternatively displayed on a display, etc. Further information regarding the system in FIG. 1 can be found in co-pending application Ser. No. 08/443,062, described above.

Further improvements to fleet management apparatus and methods providing enhanced graphical feedback of the status of a fleet, to a fleet manager and to fleet drivers will enhance efficiency.

### SUMMARY OF THE INVENTION

The present invention relates to an apparatus for graphically tracking the location and status of mobile transmitter units.

According to a one embodiment, a computer system including a display coupled to a positioning system, for forming an output display, includes a display manager coupled to the display for displaying an image of a particular geographic area on the display, and a raster map database including images of a geographic area, a raster map loader coupled to the raster map database and to the display manager for retrieving the image of the particular geographic area from the raster map database. The embodiment also includes an icon manager coupled to the display for displaying icons on the display, a data manager coupled to the display for displaying vehicle data and vector data on the display, and a distributor coupled to the icon manager, to the data manager, and to the positioning system, for receiving the vehicle data and the vector data from the positioning system and for updating the data manager and the icon manager.

According to another embodiment a computer system including a display coupled to a positioning system and to a geocoder system, for forming an output display, the computer system includes a display manager coupled to the display for displaying an image of a particular geographic area on the display, a raster map database including images of a geographic area, a raster map loader coupled to the raster map database and to the display manager for retrieving the image of the particular geographic area from the raster database, a vector database describing the geographic area, and a vector map loader coupled to the vector database and to the display manager for forming the image of the particular geographic area. The embodiment also includes an icon manager coupled to the display for displaying icons on the display, a data manager coupled to the display for displaying vehicle data and vector data on the display, a distributor coupled to the icon manager, to the data manager, to the positioning system and to the geocoder system, for receiving the vector data from the geocoder system, for receiving the vehicle data from the positioning system and for updating the data manager and the icon manager, and a callback manager coupled to the display manager and to the distributor for determining the particular geographic area.

### BRIEF DESCRIPTION OF THE DRAWINGS

FIG. 1 illustrates one of the first fleet management systems that provided enhanced graphical displays to the fleet manager;

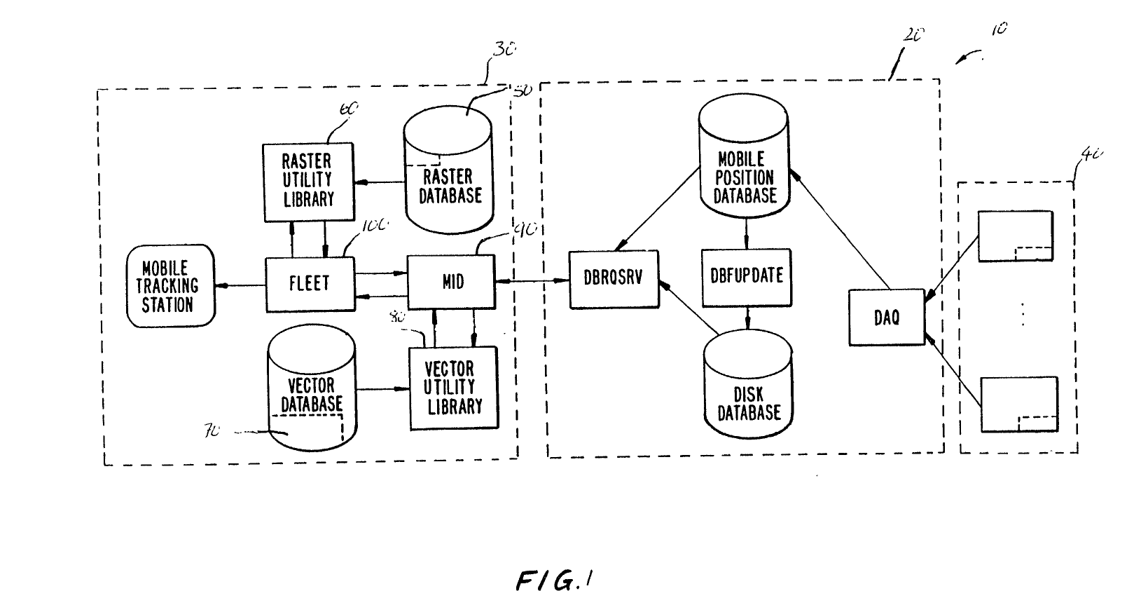

FIG. 2 illustrates a typical output display produced by one embodiment of the system in FIG. 1;

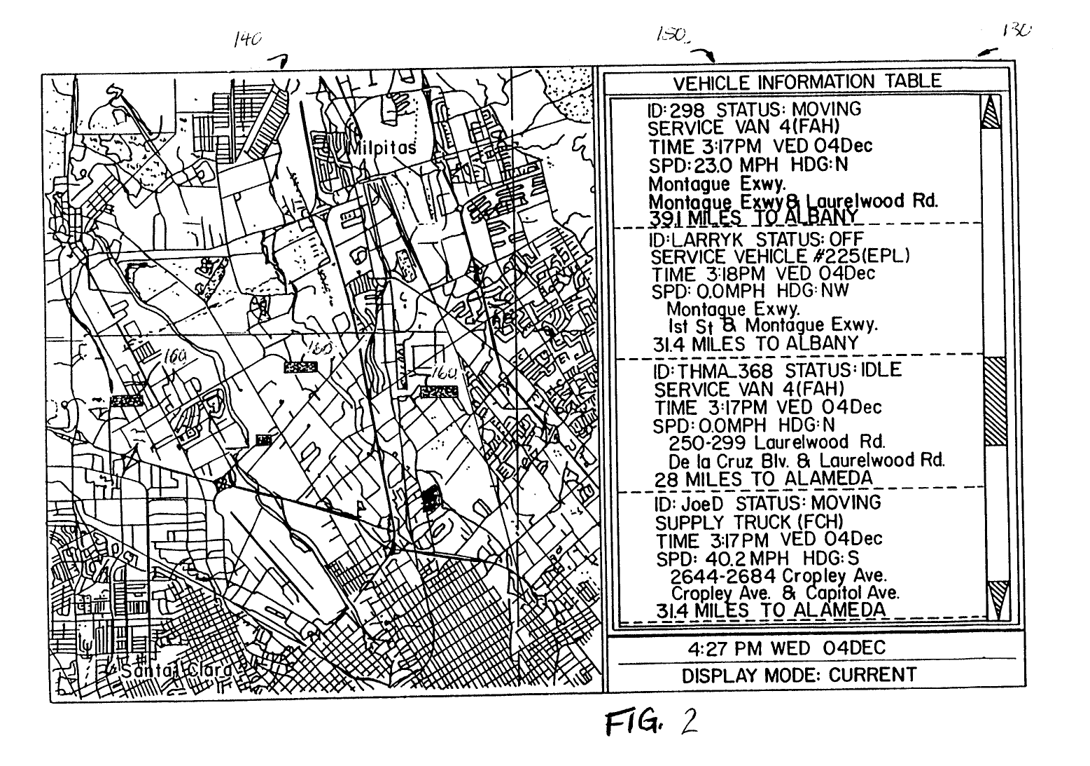

FIG. 3 illustrates a computer system according to a preferred embodiment of the present invention;

FIG. 4 illustrates a more detailed preferred embodiment of the present invention; and

FIG. 5 illustrates a preferred embodiment of the communication channels used by Dispatcher 360 to communicate with external processes.

### DESCRIPTION OF PREFERRED EMBODIMENTS

1. Definitions

Raster Map: An image of a geographic area derived from a raster database.

Raster-scan display (Rasterized display): This is a well known display format in which an image is formed on a display screen by refreshing the image on the display in a left-to-right, top-to-bottom fashion. Televisions and computer displays, including flat-panel displays, typically output data in the raster-scan display format.

Vector Data: Data derived from a vector database.

Vector Map: An image of a geographic area derived from a vector map database. Typically inferior to raster maps because of relative lack of geographical elements such as landmarks and terrain, etc., however typically superior to raster maps in terms of compactness of the database.

Vector-scan display: This is a well known display format in which an image is formed on a display by directing an electron beam on the display by the use of vectors (pairs of coordinates). Computer Aided Design and Computer Aided Manufacturing engineering systems typically output data in a vector-scan display format.

2. System Overview

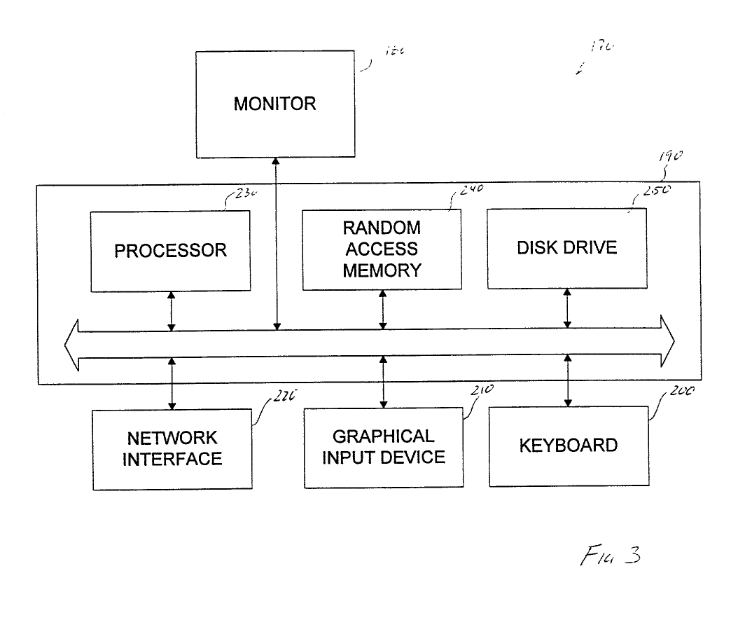

FIG. 3 illustrates a computer system according to a preferred embodiment of the present invention. System 170 includes a display screen (monitor) 180 a computer 190, a keyboard 200 a graphical input device 210, and a network interface 220. Computer 190 includes familiar computer components such as a processor 230 and memory storage devices, such as a random access memory (RAM) 240, a disk drive 250, and a system bus 260 interconnecting the above components.

A mouse is but one example of a graphical input device, also known as a pointing device, trackballs, light pens, and digitizing tablets are examples of others. RAM 240 and disk drive 250 are examples of tangible media for storage of computer programs such as embodiments of the herein described methods. Other types of tangible media include, merely for example, floppy disks and removable disks, optical storage media such as CD-ROMS and bar codes, and semiconductor memories such as flash memories, read-only-memories (ROMS), and battery-backed volatile memories.

The preferred embodiment of the present invention is implemented on a Sun Microsystems SparcStation 5, including 32 Megabytes of RAM and 1.5 Gigabytes of hard disk space. The SparcStation includes the Solaris 2.4 Operating System, X Windows Release 5, Motif Window Manager (MWM) 1.2.3, raster map to vector databases, and proprietary FleetVu (TM) software available from Mobile Information Systems, Inc. It is contemplated that other computer platforms such as '586 class based computer, Power PC based computers, SPARC and ULTRASPARC computers, etc. and other computer operating systems such as DOS, WINDOWS NT, MacOS, UNIX, etc. can be used to embody the present invention, and are thus included in alternative embodiments of the present invention.

3. Brief Overview

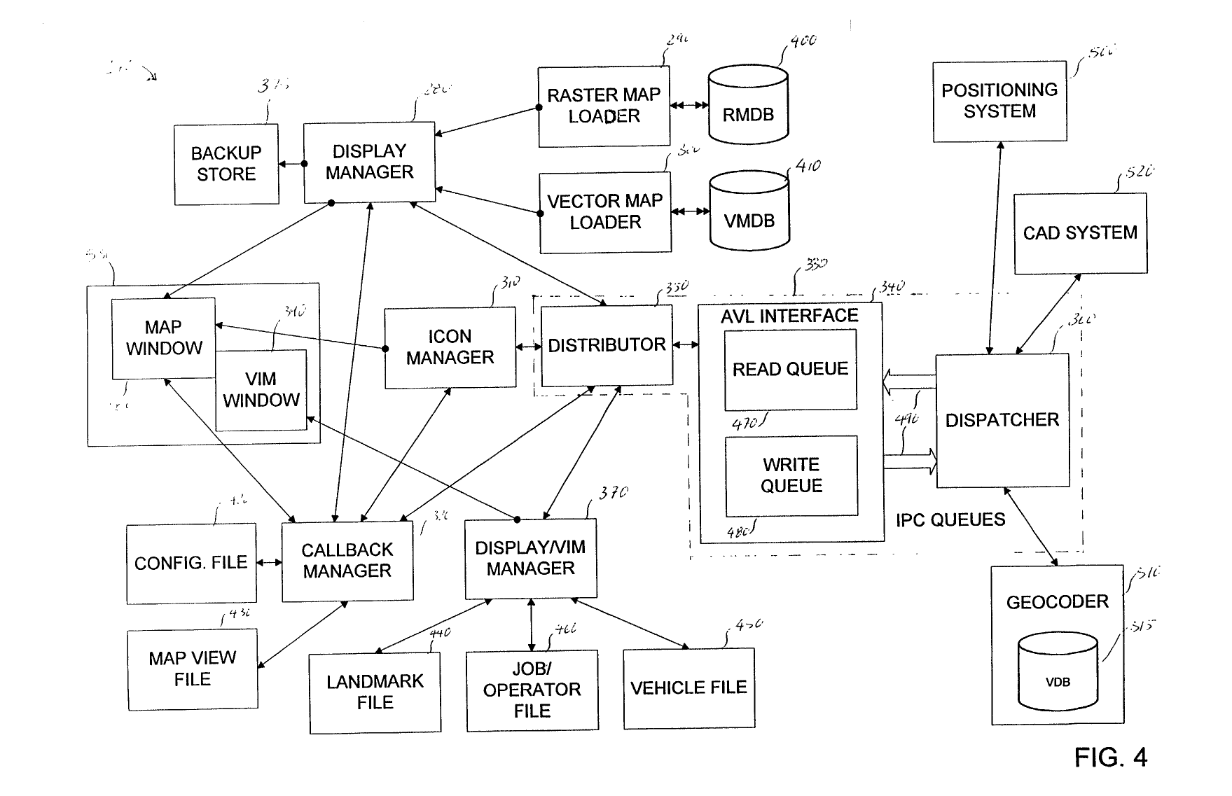

FIG. 4 illustrates a more detailed preferred embodiment of the present invention. System 270 preferable includes a display manager 280, a raster map loader 290, a vector map loader, an icon manager 310, a callback manager 320, a distributor system 330 including an automatic vehicle locator (AVL) interface 340, a distributor 350, and a dispatcher 360, a data manager 370, a map window 380, and a vehicle information matrix (VIM) window 390. System 270 also includes raster (map) database 400, vector (map) database 410, configuration files 420, map view files 430, landmark files 440, vehicle files 450, and job files 460. AVL interface 340 includes a read queue 470 and a write queue 480, and communicates with dispatcher 360 through IPC (Inter Process Communication) queues 480.

System 270 is typically coupled to a positioning system 500, a geocoder system 510, and a computer-aided-dispatch (CAD) system 520. Geocoder system 510 typically includes a vector database 515. Any available positioning system, geocoder system, or dispatching system can be used in conjunction with the below described methods and apparatus. Further information regarding these systems can be found in the above referenced co-pending applications.

As illustrated in FIG. 4, a physical display screen 530 is typically used to display information to the user. In particular, VIM window 390 displays vehicle information to display screen 530 and map window 380 displays a map to display screen 530. Superimposed on map window 380 are icons managed by icon manager 310.

Display Manager 280 is responsible for displaying maps on a physical display screen. The maps are shown on the display by using the services provided by this module.

Raster Map Loader 290 loads raster maps from raster map database 400 based on requests from Display Manager 280. The maps are converted from a native format, for example TIFF, to a format understood by Display Manager 280. The loaded maps are then passed back to Display Manager 280.

Vector Map Loader 300 generates vector maps from information in vector map database 410, based on requests from Display Manager 280. These vector maps are generated in a format understood by Display Manager 280. The generated maps are then passed back to Display Manager 280 for display.

Icon Manager 310 provides services, as will be discussed below, to display icon(s) on display screen 530.

Callback Manager 320 handles the user requests by processing the user input and then distributing the request to the appropriate modules. User generated events such as keyboard input, mouse clicks, etc. are also processed by this module.

Dispatcher 360 provides external communication with other process or programs such as positioning system 500 (Mtsmain Process Manager, Current Reports Receiver, History Reports Receiver), geocoder system 510, and CAD system 520. The functionality of the present invention thereby enhances the ease of use of such external systems.

AVL Interface 340 communicates with Dispatcher 360 via IPC queues 480. The messages received from Dispatcher 360 are passed on to Distributor 350. AVL Interface 340 comprises of Read Queue 470 and Write Queue 480.

Distributor 350 receives messages from AVL Interface 340. These messages are used to update Map Window 380 via Display Manager 280 and to update VIM window 390 via Data Manager 370. Distributor 350 also transfers requests for vehicle information, received from Callback Manager 320 to AVL Interface 470 and out to external processes.

Data Manager 280 maintains information about all the vehicles being tracked, landmarks, jobs, etc., manages VIM Window 390, and provides functions to access and update VIM window 390.

Map Window 380 is a computer window displayed on display screen 530 where a map is displayed and where the user interacts with the system 270. A first map window on display screen 530 is termed a “parent window and subsequent map windows are termed “child” windows.

VIM Window 390 is a computer window displayed on display screen 530 where a Vehicle Information Matrix (VIM) is displayed. As will be discussed, the VIM includes data derived from Vector Database 515 located in Geocoder system 510.

A VDT Manager (not shown) provides services to display and update a Vehicle Display Table (VDT) for a particular vehicle.

A detailed description of modules in FIG. 4 providing the above functionality is discussed below.

4. System Architecture

4.1. The Display Manager

4.1.1. Overview

Display Manager 280 provides services to display both raster and/or vector maps to display 530. Display Manager 280 interface is such that the operations required to retrieve/generate the two kinds of maps is done transparently. Display Manager 280 internally communicates with either Raster Map Loader 290 or Vector Map Loader 410, in order to display raster maps or vector maps on display 530.

For raster maps, Display Manager 280 requests Raster Map Loader 290 to retrieve an (appropriate) raster map from raster map database 400, typically by specifying a latitude/longitude (L/L coordinates). Raster Map Loader 290 receives the L/L coordinates, identifies the appropriate raster map that includes the L/L coordinates, preferably converts the raster map to an Ximage format, and then passes the data to Display Manager 280. Display Manager 280 uses this Ximage to preferably draw into an offscreen pixmap (Backup Store 375).

For vector maps, Display Manager 280 requests Vector Map Loader 300 to generate an (appropriate) vector map from vector map database 410, typically by specifying a latitude/longitude (L/L coordinates). Vector Map Loader 300 receives the L/L coordinates, identifies the appropriate raster map that includes the L/L coordinates, generates the vector map in an Ximage format, and then passes the data to Display Manager 280. Display Manager 280 uses this Ximage to preferably draw into an offscreen pixmap (Backup Store 375).

In both cases, Display Manager 280 ends up with an offscreen pixel map of the map, either raster or vector. Display Manager 280 then displays this pixel map to display 530. Display Manager 280 preferably includes Backup Store 375 preferably for refreshing purposes. In a preferred embodiment, Backup Store 375 is at least equal to the size of the largest possible physical window, and can easily be made larger in alternative embodiments. In alternative embodiments, Backup Store 375 can be omitted.

Display Manager 280 also maintains information about map windows currently being displayed on display 530.

4.1.2. Functions

Display Manager 280 includes the following function calls:

dm_showTopLevel(WindowId)—Draws a top level map (raster or vector) of a definable geographic region in the given window on the display. This is preferably the map seen by the user when system 270 is first invoked. The window on the display is identified by its WindowID.

dm_refreshMap(WindowId, WinArea)—Redraws portions of the screen based on a given window area, for example, when a child window is closed. This is typically done by referring to a backup image stored in Backup Store 375 or by retrieving the map from the appropriate database. The portion of the window to redraw is identified by a WinArea pointer.

dm_drawMap(WindowId, MapArea)—Draws a map in the given display window on the display, based on a given geographical area. The map (raster or vector) is drawn such that the north-west corner of the map area (retrieved) is aligned with the north-west corner of the display window. A backup image is used to extract the map area to be drawn, where ever possible from Backup Store 375. If the Backup image does not fully contain the map area to be drawn, map loaders 290 or 300 (depending upon the current map mode) is used to load the desired map area in the backup image. The geographical area is identified by a MapArea pointer.

dm_getMapCoord(WindowId, MapArea)—Retrieves the north-west latitude and longitude and the height and width or north-west and south-east latitude and longitude positions in the window.

dm_zoom(WindowId, enum Direction, enum InputType, . . . )—Sets a zoom ratio based on a given InputType. The InputType can be a POINT or AREA. If the InputType is POINT, the map is zoomed in or out such that, the given point is in the center of the map display after the zooming operation is over. If the InputType is AREA, the north-west corner of the original map area is zoomed in or out and the resulting map area is aligned with the north-west corner of the display window. This function works both for raster and vector modes.

dm_changeMapType(WindowId, enum MapType)—Changes the map display mode from vector map to raster map or from raster map to vector map. This function prepares the window for a draw but does not effect the current map displayed.

dm_centerMap(WindowId, MapPoint)—This function redisplays a map in a window such that the given geographical point is in the center of the window. If the given geographical point cannot be centered, which may happen if it is on the database boundary, the best possible area is displayed. The position on the map is identified by a MapPoint pointer.

dm_getMapCenter(WindowId, MapPoint)—Returns the geographical point of the center of the map displayed in the window. In other words, the center of the map currently displayed in the window identified by WindowID is returned to the user.

dm_installMapContext(MapContext)—Stores a pointer to MapContext in array of MapContexts and returns a WindowId for this MapContext. The MapContext describes preferably describes the parameters of the map, and the MapContext is used for identification and manipulation of the window.

4.2. The Raster Map Loader

4.2.1. Overview

Raster Map Loader 290 loads images of raster maps from raster map database 400 in response to requests from Display Manager 280. The raster maps are converted from its native format, preferably a TIFF file format, to the format understood by Display Manager 280. The converted maps are then passed back to Display Manager 280.

4.2.2. Functions

Raster Map Loader 290 includes the following function calls:

rml_getAreaTileIds(MapArea area, int xtile, int ytile, TileId Ids) Searches raster map database 400 and returns the TileIds that displays a particular geographic area identified by a MapArea pointer, and at the current scale (zoom level). To draw the raster maps, the TileIds are used to retrieve the image data.

rml_getTileData(TileId Id, void databuf, int bufsize)—Reads tile data from the raster map file for the given TileId pointer. The data is preferably returned in Zbitmap format, which is used for generating X images under the X windows environment. Other types of image formats for display and/or storage are contemplated in alternative embodiments.

rml_changeScale(enum Scale newScale)—Changes the scale of the map to be retrieved from raster map database 400. All subsequent raster map loader (rml) services operate at this new Scale. The Scale values can be NEXT, or PREVIOUS. If the current scale is at the highest or lowest possible value, a NEXT or PREVIOUS (respectively) will have no effect on the current scale. In the preferred embodiment, five scale levels of raster map images are provided. In alternative embodiments, providing greater or fewer number of scaled raster map images is also contemplated.

rml_getTileIds(MapPoint nw, int xtile, int ytile, TileId Ids)—Given a point identified by a MapPoint pointer, this function returns tileIds of a raster map. Preferably, the retrieved map area is arranged in an x-y matrix format with x tiles referring to a position in the x direction and y tiles referring to a position in the y direction.

4.3. The Vector Map Loader

4.3.1. Overview

This module generates the vector maps from vector map database 410 in response to requests from Display Manager 280. The vector maps are drawn into an offscreen pixel map (Backup Store 375), and Display Manager 280 updates the displayed map area using this offscreen pixel map.

In the preferred embodiment of the present invention, vector map database 410 and vector database 515 are one in the same. Vector maploader 300 and geocoder system 510 thus access the same database; vector maploader 300 for generating a vector map and geocoder system 510 for retrieving vector data.

4.3.2. Functions

Vector Map Loader 300 includes the following function calls:

vml_drawMap(WindowId, MapArea)—Draws a map in the offscreen pixmap based on a given geographical area. The vector map is drawn such that the four corners of the vector map area (retrieved) are aligned with the four corners of the offscreen pixmap in Backup Store 375.

vml_init(WindowId)—Initializes the data structures required by vector map database 410 to generate a vector map for the given window.

4.4. The Icon Manager

4.4.1. Overview

This module provides an interface to manipulate vehicles, jobs, landmark operator, and any other icons to be displayed on display 530. Icons are drawn, erased or updated using the services provided by this module. This module also maintains the positions and status of all icons currently displayed in the map area of a given window preferably in response to information from distributor 350. All services that erase icons are also responsible for redrawing the map area beneath the erased icon.

4.4.2. Vehicles

In the preferred embodiment of the present invention, the term “vehicles” include flat bed trucks, refrigerated trucks, cars, motorcycles, golf carts, or any mobile unit, such as a person. What is preferably required is that a transmitter is associated with the mobile unit and transmits its location. Icon Manager 310 includes the following vehicle function calls:

im_drawAllVehicles( )—Draws all vehicle icons that are defined in the currently shown map area.

im_drawVehicle( )—Draws a particular, given vehicle icon if the vehicle's position is currently within the visible map area on display 530.

im_eraseAllVehicles( )—Erases all currently displayed vehicle icons in the map area on display 530.

im_eraseVehicle( )—Erases a given vehicle icon in the map area.

im_updateVehicle( )—Indicates that a vehicle has moved, and that the vehicle icon should be erased and redrawn in the new position. If map window is in FOLLOW_VEHICLE mode and if vehicle moves out of the displayed map area, the map is re-centered (using dm_centerMap( )), and the vehicle icon is placed in the center of the map.

im_updateOperatorStatus( )—Updates the vehicle icon with the given operator status, such as on break, on assignment, or idle.

im_drawHistoryData( )—Draws the vehicle icons based on a given historical data set, i.e. historical information. In addition to drawing the vehicle icons, connecting lines are shown.

4.4.3. Landmarks

In the preferred embodiment of the present invention, the term “landmarks” may include cities, post offices, buildings, airports, port facilities, forests, rivers, sand bunkers, greens, etc. Different classes of landmarks can be defined and used. Icon Manager 310 includes the following landmark function calls:

im_drawAllLandmarks( )—Draws all user defined landmark icons that are defined in the currently shown map area on display 530.

im_drawLandmark( )—Draws a particular, given landmark icon if it is within the visible map area.

im_eraseAllLandmarks( )—Erases all currently displayed landmark icons in the map area.

im_eraseLandmark( )—This function erases a given landmark icon from the map area.

4.4.4. Jobs

Icon Manager 310 includes the following job function calls:

im_drawAllJobs( )—Draws all job icons that are defined in the currently shown map area on display 530.

im_drawJob( )—Draws a particular, given job icon if the job's location is currently within the visible map area.

im_eraseAllJobs( )—Erases all currently displayed job icons in the map area.

im_eraseJob( )—Erases given job icon in the map area.

4.4.5. Miscellaneous

Icon Manager 310 includes the following function calls for all icons:

im_drawAllIcons( )—Draws all vehicle, job, operator, landmark, etc. icons that are defined in the currently shown map area on display 530.

im_eraseAllIcons( )—Erases all vehicle, job, operator, landmark etc. icons that are displayed in the visible map area.

im_updateIconPositions( )—Recalculates all vehicle, job, operator, landmark, etc. positions for icons which may shift when the map is scrolled or zoomed.

im_findFirstIcon( )—Returns information about a first icon in a linked list of icons.

im_findNextIcon( )—Returns information about the next icon in the linked list of icons. A NULL is returned if no more icon information is available This function is used with im_findFirstIcon( ) to iterate over the link list of icons.

4.5. The Callback Manager

4.5.1. Overview

Callback Manager 320 handles the user requests by distributing the request to the appropriate module. Callback Manager 320 refers to configuration file 420 for user preferences and map view file 430 for predefined map views. Callback Manager 320 also receives information from distributor 350 and updates appropriate modules.

4.5.2. Open Map Function

In the preferred embodiment of the present invention, there are two types of display windows for display of maps to the user: parent and child. The parent window is defined as the first display window on the display screen. Child windows are defined as any subsequent display window on the display screen. Children windows may display portions of a map that are not currently visible within the parent window, or may display a portion of the map visible in the parent window in a zoomed resolution, or may display an entirely different geographical area from the parent window, for example. In a preferred embodiment of the present invention, certain functions available to the parent window are unavailable to children windows.

The Open Map function provides the user the ability to open a new map in a separate child window on display 530. This function, preferably includes the following function calls:

cm_createMapContext( )—Allocates a new MapContext data structure, assigns pointer to this newly created MapContext to the array of MapContexts, and Copies the contents of the parent window's MapContext into the newly allocated MapContext:

In a preferred embodiment, the following parameters of the parent window are copied to the child windows: Zoom level; Mode of operation—current or historical; Size of map in geographical coordinates; Size of map in X Window coordinates; Size of map in square miles; Map type—raster or vector; Geographical coordinates in center of map; and Backup image.

Further, in a preferred embodiment, the following are assigned uniquely for the child window: Identification tag; Map widgets; Window type—main or child.

cm_createMapWidgets( )—Creates the widget tree for the child Map Window. As used herein, widgets refer to menu bars, toolbars, drawing areas, footer areas, etc.

cm_installCallbacks( )—Installs callbacks for widgets in widget tree. Assigns widget tree to the allocated MapContext.

cm_displayChildWin( )—Displays the child window.

cm_grayMenuItems( )—Grays out menu items unavailable to the child window: File(Open . . . ); File(Setup . . . ); File(Print Vehicle Information Matrix.); Utilities(Brightness.).

When an expose event is generated by the X server, the map is displayed.

4.5.3. Expose Events

This function provides the ability to refresh map areas when the map in the display window is scrolled or resized. Expose events are generated by the X server for the drawing area when the Map Window is either resized or scrolled. The expose event structure includes the starting position, height and width of the exposed region.

dm_refreshMap( )—Redraws a portion of screen now exposed.

4.5.4. Zoom Operations

This function provides the ability to handle zoom operations requested by the end user or another process. These zoom operations include zooming in, out, to a selected area, to the top level, and re-centering. All the zoom operations make use of the dm_zoom( ) interface provided by Display Manager 280.

4.5.4.1. Zoom In

In order to zoom in, i.e., decrease the amount of geographic area visible in a display window, this function, preferably includes the following function calls:

utils_changeCursor( )—Change cursor shape, typically into an icon appearing as a magnifying glass with a “+” symbol.

err_updateFooterMsg( )—Updates a textual footer area to display message “In Zoom In mode.” An ‘Esc’ will cancel this operation.

utils_getCursorPos( )—Gets x,y positional coordinates of a cursor on display 530 upon receipt of user input, such as a mouse click.

utils_xy2ll( )—Converts the coordinates x,y to a longitude/latitude coordinate pair (L/L coordinates).

dm_zoom( )—called with the parameters: Direction as ZOOM_IN; INPUT as POINT; L/L coordinates at mouse click.

utils_changeCursor( )—Restores cursor shape to original.

4.5.4.2. Zoom Out

In order to zoom out, i.e., increase the amount of geographic area visible in a display window, this function, preferably includes the following function calls:

utils_changeCursor( )—Changes cursor shape, typically into a magnifying glass with a “−” symbol.

err_updateFooterMsg( )—Updates footer area to display message “In Zoom Out mode.” An ‘Esc’ will cancel this operation.

utils_getCursorPos( )—Gets x,y coordinates at mouse click.

utils_xy2ll( )—Converts x,y to L/L coordinates.

dm_zoom( )—Called with the preferred parameters: Direction as ZOOM_OUT; INPUT as POINT; L/L coordinates at mouse click.

utils_changeCursor( )—Restores cursor shape to original.

4.5.4.3. Hotkey Zoom

In the preferred embodiment of the present invention, there are two ways to zoom in or out: Hotkey or Rubberband. In Hot Key mode, described above, preferably a zoom of a raster map is another raster map, and alternatively, a zoom of a vector map is another vector map. In Rubberband mode, however a zoom of a raster or vector map is preferably a vector map.

In Hotkey mode, the amount of zoom in or out is typically predefined. Thus, the user may hit a key on the keyboard or click a mouse button to invoke this zoom mode. Using the hotkey, the Zoom In and Zoom Out operations include the following function calls:

utils_changeCursor( )—Change cursor shape, typically to a magnifying glass.

err_updateFooterMsg( )—Updates text footer area to display message “In Zoom Out mode” or “In Zoom In mode”. An ‘Esc’ will cancel this operation.

utils_getCursorPos( )—Gets x,y coordinates at mouse pointer position.

utils_xy2ll( )—Converts x,y coordinates to L/L coordinates.

dm_zoom( ) called with the following parameters: Direction as ZOOM_OUT or ZOOM_IN; INPUT as POINT; L/L coordinates at mouse click.

utils_changeCursor( )—Restores cursor shape to original.

4.5.4.4. Selective Zoom

In “Rubberband” mode, the amount of zoom in is typically defined by the area selected by the user with a cursor on display 530. In order to Rubber band to Zoom In, preferably the following functions are called:

utils_changeCursor( )—Changes cursor shape.

err_updateFooterMsg( )—Updates the textual footer area to display message “Select area to Zoom In.” An ‘Esc’ will cancel this operation.

cm_rubberBand( )—Allows the user to draw a “rubber band” marking area to zoom into, in a well known manner. Return North-west and South-east L/L coordinates of the map.

dm_changeMapType( )—Switches from raster to vector mode, if map is currently of type raster.

dm_zoom( )—called with the parameters: Direction as ZOOM_IN; INPUT as AREA; North-west and South-east longitude/latitude.

utils_changeCursor( )—Restores cursor shape to original.

4.5.4.5. Toplevel (Unzoom)

In order to return to the lowest magnification level of the current map, the following function is called:

dm_showTopLevel( )—Shows the top level of the map are covered by system 270.

4.5.4.6. Center

In order to center the map on a position defined by the user, the following functions are preferably called:

utils_changeCursor( )—Changes cursor shape.

err_updateFooterMsg( )—Updates footer area to display message “Recentering Map.” An ‘Esc’ will cancel this operation.

utils_getCursorPos( )—Gets x,y coordinates at cursor position on display 530.

utils_xy2ll( )—Converts x,y coordinates to L/L coordinates.

dm_centerMap( )—Centers map around determined L/L coordinates.

utils_changeCursor( )—Restores cursor shape to original.

4.5.5. Change Mode (Current, History)—cm_changeMode( )

There are two modes provided in the preferred embodiment of the present invention: current and history. In current mode, the locations, status, etc. of jobs, drivers, vehicles, etc. are based upon current data provided by dispatch 360, from external processes such as positioning system 500 and CAD system 520. In history mode (historical mode), the location, status, etc. of job, drivers, vehicles, etc. are based upon historical data retrieved from the external processes. In either mode, certain functionality is provided that is unavailable in the other mode.

To switch the map area between current and history modes, the cm_changeMode( ) function preferably takes an enum parameter to indicate the mode to switch to.

In order to switch to current mode, the following functions are called:

im_eraseAllIcons( )—Removes all displayed icons from the map; Changes mode of operation in MapContext to CURRENT_MODE.

im_drawAllIcons( )—Displays current relevant icons, requested by the user; Grays out the Analysis menu option; Grays out the Find(Sequence menu option; Grays out the Mode(Current Mode menu option.

In order to switch to history mode, the following functions are called:

im_eraseAllIcons( )—Removes all displayed icons from the map; Changes mode of operation in MapContext to HISTORY_MODE.

im_drawHistoryData( )—Displays historically relevant icons requested by the user; Activates the Analysis menu option; Activates the Find:Sequence menu option; Grays out the Mode:History Mode menu option.

hdm_findReport( )—Gets L/L coordinates of a first vehicle in the sequence.

dm_centerMap( )—Centers map around this L/L.

4.5.6. Follow Vehicle—cm_followVehicle( )

In the preferred embodiment of the present invention, this functionality allows the user to automatically follow a target vehicle within the mapped geographical area. Typically, a child window is opened with the icon of the target window centered in the child window. As the vehicle moves, the portion of the map displayed in the child window is automatically scrolled such that the vehicle icon remains roughly in the center of the child window. Alternatively, when the map window is in the FOLLOW_VEHICLE_MODE, and the vehicle reaches the edge of the map window, the map will be re-centered such that the vehicle is in the center of an updated map in the map window. This functionality is handled by im_updateVehicle( ).

In order to implement the follow vehicle functionality, the following functions are called:

cm_followVehDialog( )—Creates and posts the follow vehicle dialog. Gets the identification number of the vehicle to be followed. Changes mode of operation in MapContext to FOLLOW_VEHICLE_MODE.

im_eraseAllIcons( )—Erases all vehicle icons from the map.

vdm_findVehicle( )—Gets L/L Coordinates of the vehicle to be followed.

dm_centerMap( )—Centers the map around this longitude/latitude.

im_drawAllLandmarks( )—Draws all landmarks, preferable, but not required.

im_drawVehicle( )—Draws the vehicle icon.

err_updateFooterMsg( )—If at maximum zoom level or outside of the map databases, map area to be shown is not available, display error message “Map Coverage not available.”

4.5.7. Find Vehicle—cm_findVehicle( )

In order to allow the user to visually locate a specific vehicle of interest, and center the map around it, the following functions are called:

cm_findVehDialog( )—Creates and posts the follow vehicle dialog. Typically a window providing the user with vehicle information. Gets the identification number of the vehicle to be found.

im_eraseAllIcons( )—Erases all vehicle icons from the map.

vdm_findVehicle( )—Gets L/L coordinate information of the vehicle to be found.

dm_centerMap( )—Center the map around this L/L.

im_drawAllIcons( )—Draw icons, such as landmarks, preferable, but not required.

im_drawVehicle( )—Draws the vehicle icon, so that it appears on top.

vim_scrollToTop( )—If Vehicle Information Matrix is visible, scroll it to show the vehicle at the top of the scrolling list.

4.5.8. Find Job—cm_findJob( )

In order to allow the user to visually locate a specific job of interest, and center the map around it, the following functions are called:

cm_findJobDialog( )—Creates and posts the find job dialog. Get the ID of the job to be found.

im_eraseAllIcons( )—Erases all vehicle icons from the map.

jobs_findJob( )—Gets longitude/latitude information of the job to be found.

dm_centerMap( )—Centers the map around this longitude/latitude.

im_drawAllIcons( )—Draw all icons, such as landmarks. Preferable, but not required.

im_drawJob( )—Draws the job icon, so that it appears on top.

4.5.9. Find Landmark—cm_findLandmark( )

In order to allow the user to visually locate a specific landmark of interest, and center the map around it, the following functions are called:

cm_findLmkDialog( )—Creates and posts the find landmark dialog. Get the landmark id to be found.

im_eraseAllIcons( )—Erase all vehicle icons from the map.

mk_findLandmark( )—Gets L/L information of the landmark to be found.

dm_centerMap( )—Centers the map around this longitude/latitude.

im_drawAllIcons( )—Draws all icons, such as vehicles and jobs. Preferable, but not required.

im_drawLandmark( )—Draws the landmark icon, so that it appears on top.

4.5.10. Find Sequence—cm_findSequence( )

In the preferred embodiment of the present invention, <Sanjiv: What are sequences?> In order to allow the user to visually locate a specific landmark of interest, and center the map around it, the following functions are called:

cm_findSeqDialog( )—Creates and posts the find sequence dialog. Get the sequence id to be found.

hdm_findReport( )—To obtain the L/L of desired sequence.

im_eraseAllIcons( )—Erases all icons from the map.

dm_centerMap( )—Centers the map around this longitude/latitude.

im_drawAllLandmarks( )—Draws all landmarks. Preferable, but not required.

im_drawHistoryData( )—Draws the history data on the map.

4.5.11. Vehicle Proximity Locate—cm_locateVehicle( )

In order to allow the user to quickly determine vehicles with a proximity of a user-defined position on the display window, the following functions are called:

utils_changeCursor( )—Change cursor shape.

err_updateFooterMsg( )—Updates footer area to display message “In Vehicle Locate Mode.” An ‘Esc’ will cancel this operation.

utils_getCursorPos( )—Gets x,y coordinates at mouse pointer position.

utils_getProxRadius( )—Gets “pre-specified distance” preferably from configuration file 420. This pre-specified distance is the “radius” around the pointer position, and defines a proximity. Search link list of icon manager and compare the x,y coordinates of mouse click to x,y coordinates of each vehicle icon.

cm_locateVehDialog( )—Posts dialog box showing vehicles whose x,y coordinate positions lie within the pre-specified distance from the mouse click x,y coordinates.

utils_changeCursor( )—Restores cursor shape to original.

4.5.12. Vehicle Update—cm_updateVehicle( )

In order to allow the user to obtain an updated status of vehicles within a proximity of a user defined position on the display window, the following functions are called:

utils_changeCursor( )—Changes cursor shape.

err_updateFooterMsg( )—Updates footer area to display message “In Vehicle Update Mode.” An ‘Esc’ will cancel this operation.

utils_getCursorPos( )—Gets x,y coordinates at mouse pointer position.

utils_getProxRadius( )—Gets “pre-specified distance” from setup structure, as disclosed above. Search link list of icon manager and compare the x,y coordinate of mouse click to x,y coordinates of each vehicle icon.

cm_locateVehDialog( )—Posts dialog box showing identified vehicles whose x,y coordinates positions lie within the pre-specified distance from the mouse click x,y coordinates.

utils_changeCursor( )—Restores cursor shape to original. Get input from user about vehicle whose info is to be updated.

dis_sendVehiclePositionRequest( )—Sends polling request to the identified vehicles.

4.5.13. Display Landmark Preferences—cm_displayLmkPref( )

In the preferred embodiment of the present invention, different classes of landmarks may be defined. For example, a class of Post Office landmarks may include locations of post offices on a map, further a class of re-fueling landmarks may include locations of electric, natural gas, propane sources, etc. and still further a class of customer locations may include locations of customer delivery points. To allow the user to display and undisplay landmarks based on user preferences, the following functions are provided:

cm_dispLmkPrefDialog( )—Creates and posts the display landmark preferences dialog. Get end user input on landmarks to be displayed or undisplayed.

lmk_findFirst( )—Updates link list maintained by landmark data manager, find first landmark.

lmk_findNext( )—Find next landmark.

lmk_enableLandmark( )—Draws landmarks on map.

lmk_disableLandmark( )—Erases landmarks from map.

im_eraseAllLandmarks( )—Erases all landmarks.

im_drawAllLandmarks( )—Draw all landmarks.

cm_saveAsLmk( )—Convert a L/L coordinate as a landmark.

4.5.14. Proximity Calculations—cm_proxCalc( )

In the preferred embodiment of the present invention, distances between user-defined points in a display window can be determined. One end point may be a vehicle, and the other end a destination, for example. In another example, a golf application, the user may determine the yardage between her ball and the pin, or alternatively, her ball to the edge of a bunker utilizing the present feature. To allow the user to calculate and display the distance between two points, the following functions are called:

utils_changeCursor( )—Changes cursor shape.

err_updateFooterMsg( )—Updates footer area to display message “In Calculate Proximity Mode.” An ‘Esc’ will cancel this operation.

utils_getCursorPos( )—Gets x,y coordinates at first mouse click.

utils_xy2ll( )—Converts the first x,y coordinates to L/L coordinates.

utils_getCursorPos( )—Gets x,y coordinates at second mouse click.

utils_xy2ll( )—Converts the second x,y coordinates to longitude/latitude. Calculates the distance between the two longitude/latitudes.

cm_proxCalcDialog( )—Posts dialog box showing the distance between the two mouse clicks.

utils_changeCursor( )—Restores cursor shape to original.

4.5.15. Forward and Reverse Geocoding

In the preferred embodiment of the present invention, the term Geocoding primarily refers to locating a street address on a map or locating a street address from a point on the map. More specifically, forward geocoding refers to converting a street address to a longitude and latitude and to a point on a visible map, and reverse geocoding primarily refers to converting a point on a visible map to a longitude and latitude and then a street address.

To convert an street address to a longitude/latitude (L/L), and center the map on this longitude/latitude, the following functions are called:

cm_forwardGeoDialog( )—Creates and posts the forward geocode dialog. Gets the user input on address to be converted to longitude/latitude.

cm_addr2latlon( )—Converts address to longitude/latitude, typically by accessing geocoder 510.

im_eraseAllIcons( )—Erases all icons.

dm_centerMap( )—Centers map using above longitude/latitude.

im_drawAllIcons( )—Draws all icons on the map.

To convert a L/L coordinate to a street address, and center the map on this longitude/latitude. The following functions are called:

utils_changeCursor( )—Changes cursor shape.

utils_getCursorPos( )—Gets x,y coordinates at mouse click.

utils_xy2ll( )—Converts x,y coordinates to longitude/latitude.

cm_reverseGeoDialog( )—Creates and posts the reverse geocode dialog. Preferably get user input on closest street name.

cm_latlon2addr( )—Converts above longitude/latitude/to address. Displays addresses in reverse geocode dialog box.

utils_changeCursor( )—Restores original cursor shape.

4.5.16. Request Historical Data

To request historical data for a vehicle, the following functions are called:

cm_reqHistDataDialog( )—Creates and posts the request historical data dialog. In a preferred embodiment of the present invention, get the user input on vehicle for which historical data is to be retrieved.

hdm_flushReports( )—removes existing historical data.

dis_sendHistoryRequest( )—Requests historical data for a vehicle.

4.5.17. Analysis of Historical Data—cm_analyzeHist( )

Statistics of the historical data is user definable and is displayed to the user following functions below:

cm_statsHistDataDialog( )—Posts Statistical Analysis of Historical Data dialog box. Accept user input on configuration of Statistics.

cm_showStatistics( )—Posts dialog box with analysis of historical data, after adjusting for user defined configuration.

Further, duration of deliver, etc. is displayed to the user following the functions below:

cm_durHistDataDialog( )—Posts Duration Analysis of Historical Data dialog box. Accepts user input on configuration of Duration.

cm_showDuration( )—Posts dialog box with analysis of historical data, after adjusting for user defined configuration.

4.5.18. Show/Hide Vehicle Information Matrix

In the preferred embodiment of the present invention, a Vehicle Information Matrix (VIM) is simultaneously displayed along with map display 380 on display 530. The VIM is user-definable and may include information such as identification number, vehicle name, description of vehicle, operator, etc.; vehicle status information such as idle, running, stopped, speed, heading, etc; job status information such as early, late, time of deliver, etc. information from the vector database, such as present street address, distance to destination, nearest cross-street, etc., driver information, among other types of relevant information. Other types of information are included in alternative embodiments of the present invention, and VIM window 390 need not be simultaneously displayed with Map window 380. To display/hide VIM window 390, the following functions are provided:

vim_showVIM( )—Shows Vehicle Information Matrix.

vim_hideVIM( )—Hides Vehicle Information Matrix.

5. The Dispatcher

5.1. Overview

Dispatcher 360 runs as a separate UNIX process, but is included in the preferred embodiment of the present invention, system 270. All messages traveling to and from system 270 are communicated by Dispatcher 360.

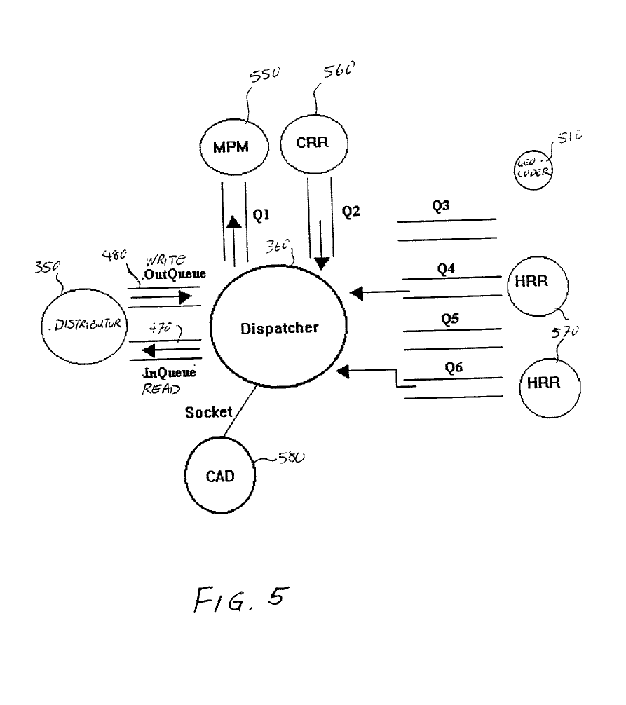

FIG. 5 illustrates a preferred embodiment of the communication channels used by Dispatcher 360 to communicate with external processes. FIG. 5 includes Dispatcher 360 in system 370, and external processes: Mtsmain Process Manager (MPM) 550, Current reports receiver (CRR) 560, Historical reports receiver (HRR) 570, and Computer-Aided-Dispatch system (CAD) 580.

CRR 560 provides current vehicle information for the Current mode and HRR provides historical vehicle information for the History mode of system 270. CAD preferably provides data regarding vehicles, drivers, jobs, schedules for displaying on display 530.

Dispatcher 360 preferably receives messages from system 370 and writes them to Mtsmain Process Manager (MPM) 550 or Computer Aided Dispatch (CAD) system 580, such as DispatchExpress available from Mobile Information Systems, Inc. Dispatcher 360 also receives messages from CAD 580, Current Reports Receiver (CRR) 560 or Historical Reports Receiver (HRR) 570 and sends them to modules within system 270.

5.2. Initialization

Upon initialization of dispatcher 360, dispatcher 360 performs the following actions: Associates to the IPC queues (Q1-Q6) 490, and Read Queue 470 and Write Queue 480 within AVL Interface 340; Opens a socket and binds itself to a well known port for accepting connections from CAD 580, i.e. dispatcher 360 behaves as a server to CAD 580.

5.3. Polling

After initialization, Dispatcher 360 enters into a polling loop. Dispatcher 360 constantly polls all the communication channels looking for data. Whenever a message arrives on any communication channel (Queues or Sockets) it is retrieved, processed, and then dispatched to the appropriate channel. A channel is not polled for new message until the last retrieved message from that channel has been processed and dispatched.

The dispatcher can be configured to use any one of the following strategies to poll the input channels including message count based polling: Reads N messages from a channel. If N>available number of messages, do not wait but move onto the next channel. Alternatively the dispatcher can include time based polling: Waits for a specified time on each channel before moving onto the next channel. Reads all messages that arrive within this time period, then move on to the next channel.

5.4. Dispatching Messages to and from System 270

Dispatcher 360 retrieves messages from System 270 typically on Write Queue 480 and reads the message header to determine the destination of the message. If the message is type CAD_MESSAGE, it is routed to the CAD process else the message is routed to the Mtsmain Process manager.

Dispatcher 360 receives messages sent by other processes to System 270 via queues Q2-Q6 490 and the socket connections and theses messages are written to Read Queue 470.

6. The AVL Interface

AVL Interface 340 communicates with Dispatcher 360 through Read Queue 470 and Write Queue 480. These queues are created (by Mtsmain Process Manager) before system 270 is launched. At start-up initialization, system 270 attaches to these queues for data transfer.

Write Queue 480 (FleetVuOutQueue) is used by system 270 for sending messages to Dispatcher 360, and Read Queue 470 (FleetVuInQueue) is used for receiving messages sent by external processes (such Positioning system 500 and CAD 520).

The AVL interface includes the following functions:

avl_scheduleRead( )—Schedules a function to be invoked every ‘n’ seconds. This function peeks into the IPC queue looking for any received messages. If a message is available it is retrieved from the queue and the dis_recvMessage( ) function is used to process the message.

avl_sendMessage( )—Writes a message packet into the outgoing IPC queue.

7. The Distributor

Distributor Module 350 receives messages from AVL Interface 340 and then updates Map Window(s) 380 and VIM window 390. Distributor 350 also transfers requests for vehicle information, received from Callback Manager 320 to AVL Interface 340.

Distributor 350 includes the following function calls:

dis_recvMessage( )—This function receives a message packet from AVL Interface 340 and determines the message type. Depending upon the type of the message, the received message is dispatched to the appropriate display window. For example:

For message type RCV_VEH_RPT—vdm_updateVehicle( ) is called to update Data Manger 370. Data Manager 370 in turn detects duplicate reports and returns the status to Dispatcher 360. If the report is not a duplicate the following functions are called: im_updateVehicle( )—updates each Map Window 380; and vim_updateVehicle( )—updates Vehicle Information Matrix;

For message type RCV_HIST_RPT—hdm_addReport( ) is called;

For message type RCV_END_HIST—Analysis menu is enabled and the function im_drawHistoryData( ) is called;

For message type READ_VID_FILE—vdm_readVehicleFile( ) is called to read a vehicle file;

For message type RCV_OPER_STS—vdm_updateOperatorStatus( ), im_updateOperatorStatus( ), and vim_updateOperatorStatus( ) are called;

For message type RCV_JOB_INFO the function jobs_updateJob( ) is called and based on information returned from jobs_updateJob( ), call: im_eraseJob( ) for deleted jobs; im_updateJob( ) for updated jobs; im_drawJob( ) for new jobs.

dis_sendHistoryRequest( )—This function generates a message packet to request historical information about a vehicle. This packet is then sent to AVL Interface 340 using the ipc_sendMessage( ) function.

dis_sendVehiclePostionRequest( )—This function generates a message packet to request current position about a vehicle. This packet is then sent to AVL Interface 340 using the ipc_sendMessage( ) function.

dis_sendReadyMessage( )—This function generates a message packet to inform AVL Interface 340 that System 270 is ready to receive messages. This packet is then sent to AVL Interface 340 using the ipc_sendMessage( ) function. At this point AVL Interface 340 can begin sending messages to System 270.

dis_sendCancelHistoryMessage( )—This function generates a message packet to cancel a request for historical information about a vehicle. This packet is then sent to AVL Interface 340 using the ipc_sendMessage( ) function.

dis_sendExitMessage( )—This function generates a message packet to inform AVL Interface 340 that System 270 is about to terminate. This packet is then sent to AVL Interface 340 using the ipc_sendMessage( ) function.

8. The Data Manager

8.1. Overview

Data Manager 370 module maintains several link lists containing preferably information about vehicles, landmarks and jobs being tracked. A separate link list is maintained for each item. It provides an interface to find, add, delete and update information from the above link lists.

8.2. Vehicles

For vehicles, Data Manager 370 provides the following function calls:

vdm_findVehicle( )—Searches the link list to return information about the queried vehicle.

vdm_findFirst( )—Returns information about the first vehicle in the link list.

vdm_findNext( )—Returns information about the next vehicle in the link list. A NULL is returned if there are no more vehicles in the list. This function is used with vdm_findFirstVehicle( ) to iterate over the link list.

vdm_updateVehicle( )—Updates the vehicle information in the link list. If the vehicle does not exist, the information is ignored.

vdm_updateOperatorStatus( )—Update the operator info for a given vehicle identification number. Indicate if the new operator status is different from the existing one.

vdm_deleteVehicle( )—Deletes the specified vehicle from the link list.

vdm_readVehicleFile( )—Read the Vehicle File to build the link list. This function is usually required only at FleetVu start-up time.

8.3. Landmarks

A link list of all landmarks is maintained. Each node of the list will have a flag to indicate whether it is enabled or not, in addition to other information about the landmark. For landmarks, Data Manager 370 provides the following function calls:

lmk_findLandmark( )—Searches the link list to return information about the queried landmark.

lmk_addLandmark( )—Add landmark to the link list.

lmk_findFirst( )—Returns information about the first vehicle in the link list.

lmk_findNext( )—Returns information about the next landmark in the link list. A NULL is returned if there are no more landmarks in the list. This function is used with lmk_findFirst( ) to iterate over the link list.

lmk_enableLandmark( )—Searches the landmark link list and marks the landmark as enabled (i.e., selected by the end user for display on the map).

lmk_disableLandmark( )—Searches the landmark link list and marks the landmark as disabled (i.e., de-selected by the end user for display on the map).

lmk_readLandmarkFile( )—Read the Landmark File to build the link list. This function is usually required only at start-up time.

lmk_saveLandmarkFile( )—Updates the landmark file on storage disk with the currently landmark(s) information.

8.4. Jobs

For jobs, Data Manager 370 provides the following function calls:

jobs_findJobs( )—Searches the queue to return information about the queried job.

jobs_findFirst( )—Returns information about the first job in the queue.

jobs_findNext( )—Returns information about the next job in the queue. A NULL is returned if there are no more jobs in the queue. This function is used with jobs_findFirst( ) to iterate over the queue.

jobs_deleteJob( )—Deletes the specified job from the queue.

jobs_updateJob( )—Update the job order in the queue. If the job does not exist, and there is room in the queue, add the job to the queue. If the job does not exist, and there is no room in the queue, remove the oldest job to make room for the new job. Return information about: the Job location updated, Job deleted, or Job added.

8.5. History

A separate history data set is maintained for each Map Window 380. Reports in a history data set can be identified with by a unique sequence number.

For history, Data Manager 370 provides the following function calls:

hdm_addReport( )—Appends the given history report to the history data set of the given map Window.

hdm_findReport( )—Searches the history data set to return the queried report.

hdm_getReportCount( )—Returns the number of reports in the current history data.

hdm_flushReports( )—Remove existing historical reports.

8.6. The VIM Manager

A Vehicle Information Matrix (VIM) Manager, herein conceptually integrated into data manager 370 is responsible for managing the Vehicle Information Matrix as previously discussed (VIM) window on the display. The VIM Manager provides the following functions:

vim_scrollToTop( )—Scrolls the Vehicle Information Matrix such that the given vehicle is at the top of the scrolling list in the VIM window.

vim_updateVehicle( )—Updates the information about the given vehicle in the Vehicle Information Matrix. If the given vehicle does not exist in the VIM, it is added. No scrolling is done upon an update or addition.

vim_showVIM( )—Displays the Vehicle Information Matrix window.

vim_hideVIM( )—Hides the Vehicle Information Matrix window.

vim_sortVehicleList( )—Given a sort key, this function will sort the vehicle link list. The key can be either VEHICLEID or LMKDISTANCE.

vim_updateVIM( )—Display information about vehicles in the list in the given Vehicle Information Matrix.

vim_updateOperatorStatus( )—Update the operator status for the given vehicle in the currently displayed VIM list. No error is returned if the given vehicle ID does not exist in the list.

9. Geocoding

A Geocoding Module provides the geocoding services Forward and Reverse, as previously discussed, by connecting to an external Geocoder 510 (Geocoding server). It connects as a client to Geocoder 510 and exchanges messages with Geocoder to perform geocoding.

The Geocoding Module provides the following functions:

geo_Connect( )—Establishes a connection to Geocoder 510.

geo_setDataReceiver( )—This function is used by the caller module to install the data receiver function. The data receiver function is called every time a message is received from Geocoder 510. A pointer to the received message is also passed to DataReceiver function. A NULL value is sent to DataReceiver upon arrival of the last message from Geocoder 510.

geo_addr2LatLon( )—This function sends a forward geocoding request to Geocoder 510. It After sending the request installs a work procedure to receive the data from Geocoder 510. The work procedure reads one message from the socket and calls the data receiver function installed via geo_addDataReciever( ). Upon reading the last message from Geocoder the work procedure un-installs itself and calls the DataReceiver function with a NULL value.

geo_LatLon2addr( )—Sends a reverse geocoding request to Geocoder 510. The mechanism used to receive data from the server is same as geo_addr2LatLon( ).

geo_Disconnect( )—Closes the socket connecting to Geocoder 510.

10. The Vehicle Display Table Manager

The Vehicle Display Table Manager (VDT) module (not shown) manages a Vehicle Display Table for a give vehicle on display 530. VDT includes the following functions:

vdt_DisplayVDT( )—Pops up the VDT for a given vehicle. If the VDT is already displayed then the contents of VDT are replaced with the current vehicle information. Also sends a job information request to CAD 520.

vdt_UpdateVDT( )—Updates the VDT with the new vehicle position. Has no effect if the VDT is not displayed.

vdt_UpdateJobInfo( )—Updates the VDT with the job information for a given vehicle received from CAD. Has no effect if the VDT contains information about other vehicle or if it is not displayed.

vdt_HideVDT( )—Dismisses the VDT.

11. Configuration File

In the preferred embodiment of the present invention, Configuration File 420 allows the user to specify the following parameters: vehicle proximity radius, number of simultaneous jobs to be displayed, landmark delta range, whether a VIM for a vehicle is displayed, number of levels of raster maps, number of states for a vehicle, filenames for landmark data, vehicle data, bitmap icon data, color data, etc.

12. Map View File

In the preferred embodiment of the present invention, Map View File 430 specifies: the number of raster maps available, the zoom levels, the L/L coordinates of the corners of the raster maps, etc.

13. Computer Aided Dispatch Interface

System 270 defines an interface to communicate with any computer aided dispatch system (CAD) 520, such as DispatchExpress, from Mobile Information Systems or any other fleet management system. The interface is a set of messages which can be exchanged between CAD 520 and System 270. These messages travel between System 270 and CAD 520 via Dispatcher 360 discussed earlier. Dispatcher 360 communicates with System 270 and CAD 520 using queues 370 and 380 and the socket illustrated in FIG. 5. System also provides GUI based communication interface to CAD system 520. The GUI interface is provided using the ‘Drag n Drop’ protocol defined, for example, by Motif.

A CAD system implementing the capabilities of system 270 herein is described in the co-pending application Ser. No. 08/443,063 filed May 17, 1995 (Attorney Docket No. 15517-000111) described earlier.

13.1. Services

Dispatcher 360 runs as a server process and periodically looks for a connection request on a well known port. Once a connection is established, CAD system 520 can use any of the following services:

Open/Close a map window: This service allows CAD system 520 to open a new map window 380. CAD system 520 can then display icons in map window 380 using icon manager 310. It is not mandatory for CAD systems to open a new window for displaying icons.

Display a job icon in a map window: This service is used by CAD system 520 to draw a set of job icons in one or more map windows 380. The information about jobs to be displayed is received in form of job sets—a list of jobs in which each job has its own properties. The properties of a job preferably determine the shape and the color of the icon used to depict that job on the map. The job set message contains a connect flag which can be set by CAD system 520 to draw connecting lines between job icons. Lines are drawn from job icon 1 to 2, 2 to 3 and so on.

Operator Status: This service is used by CAD systems 520 to display the latest operator status as an operator icon on the displayed map. The status of an operator preferably determine the shape and the color of the icon used to depict that operator on the map.

Assign jobs to operators: This service allows CAD systems 520 to assign jobs to vehicle operators using either the Drag and Drop protocol or a message interface. Drag and Drop mechanism can be used if both CAD systems 520 and System 270 are using the same display. The message approach can be used by CAD systems 520 without a Motif interface.

13.2. Messages from CAD Systems to System 270

The preferred embodiment of the present invention handles the following messages from CAD systems 520, other message handlers are also contemplated in alternative embodiments of the present invention:

Open Map (Msg Id 501)—This message is sent by CAD system 520 requesting system 270 to open a separate map Window 380 for displaying job icons only. Upon receiving this message system 270 opens a map window in a job view mode. The ID of the newly created map window will be returned to CAD system 520. CAD system 520 can then use this window ID to display job sets in this window.

Close Map (Msg Id 502)—This message is sent by CAD systems 520 to close the map window opened via the Open Map request.

Get Job Queue Size (Msg Id 503)—The information about the jobs is maintained in a circular queue. The maximum number of job icons that can be displayed is limited by the current size of the queue. CAD systems 520 queries the size of circular queue using this message.

Set Job Queue Size (Msg Id 504)—CAD systems 520 send this message to alter the size of the queue holding job information. System 520 typically imposes an upper limit on the size of the queue.

Display Job Set (Msg Id 507)—CAD systems 520 send this message to display the list of jobs in the given job set. The message packet sent by CAD system 520 contains the ID of the map window to which the job icons are to be displayed. However, an ID of ALLWINDOWS (predefined constant) may be used to draw the job icons in all map windows 380. If a new map window is opened after this message is received existing job icons will be drawn in the newly opened window too.

Assign Jobs to Vehicle (Msg Id 508)—This message is used by CAD systems 520 to assign a number of jobs to a vehicle operator. Upon receiving this message System 270 updates the operator icon to display the number of jobs assigned to that operator.

Operator Status (Msg Id 510)—This message is used by CAD systems 520 to assign a operator to a vehicle or to notify System 270 about the change in operator status.

Job Information (Msg Id 505)—This message is sent by CAD system 520 in response to Request Job Info message (Msg Id 604). This packet contains the pre-formatted data about the job for which System 270 has requested information.

Assigned Job Information (Msg Id 506)—This message is sent by CAD systems 520 in response to Request Assigned Job Info message (Msg Id 605). This message contains information about the jobs assigned to the given vehicle. System 270 imposes no restriction on the format of the returned information. The data buffer containing the information is preferably displayed as is.

13.3. Messages from System 270 to CAD Systems 520

The preferred embodiment of the present invention handles the following messages to CAD systems 520, other message handlers are also contemplated in alternative embodiments of the present invention:

Open Map Response (Msg Id 601)—System 270 sends this message in response to the Open Map (Msg Id 501) request. If a new map can be opened successfully this message contains the ID of the open map window else it contains an error code describing the reason for error.

JobQueueSize (Msg Id 602)—This message is sent in response to the Get Job Queue Size (Msg Id 503) request from CAD systems 520. It contains the current size of the job queue indicating the maximum number of jobs icons that can be displayed on a map.

Map Destroyed (Msg Id 603)—This message is sent by System 270 to notify that the map window opened by CAD system 520 has been closed upon the end user request.

Request Job Info (Msg Id 604)—This message is sent by System 270 to request additional information about a Job. This request is generated when the user wants to display detailed information about a job.

Request Assigned Job Info (Msg Id 605)—This message is sent by System 270 requesting information about the jobs assigned to a vehicle operator. This request is generated when the end user requests the VDT to be displayed.

Exit Message (Msg Id 606)—This message is sent by System 270 just before quitting. This message is generated when the end user chooses to quit System 270.

Conclusion

In the foregoing specification, the invention has been described with reference to specific exemplary embodiments thereof. Many changes or modifications are readily envisioned. For example, it is envisioned that fleet vehicles can be equipped with embodiments of the present invention, thus enabling drivers to graphically determine their geographic position, their present street address, the job status, etc. Also, many types of positioning systems, geocoder systems, and CAD systems could be easily modified to interface to the preferred embodiments of the present invention. Further, it is foreseeable that vector map technology will one day improve so as to be equivalent to current raster maps, i.e. including geographic data. Thus, raster map databases may not be needed in alternative embodiments of the present invention.

The presently claimed invention may also be applied to other areas of fleet management than transportation services described above. For example, an embodiment of the claimed invention may be used in a golf course environment with transmitters installed in each golf cart. A fleet manager at the club house is then able to graphically track the progress of golfers on the course, zoom-in on selected portions (holes) of the golf course to determine where there are back-ups or slow players, etc. Further, if embodiments of the present invention are installed on individual golf carts, the users are able to graphically determine their position on the course, or on a hole. The users thus are able to see the geographic layout of a hole, including trees, bunkers, rough, etc., and can determine the distance from their cart to user-selected locations on the screen (proximity function). For example, distance to the rear-edge of a bunker, to the front edge of a ravine, to the pin, etc. Since pin placement on a green typically varies each day, the maps can be updated daily, and the users can be given up-to-date layouts of the course.

In another example, an embodiment of the claimed invention may be used by schools or parents, with pager-sized transmitters carried by their children. A Parent could then be able to graphically track her children within the neighborhood. Further, the parent could quickly determine the street address of her children and pick them up, if the children are lost.

Although the above description fully describes a preferred embodiment of the present invention, implementation specific details and data structures are described in the attached Detailed Design and Functional Specification in Appendix A. Further integration of the preferred embodiment with positioning systems, geocoder systems, and CAD systems is also described in Appendix A.

The specification and drawings are, accordingly, to be regarded in an illustrative rather than a restrictive sense. It will, however, be evident that various modifications and changes may be made thereunto without departing from the broader spirit and scope of the invention as set forth in the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed:

1. A computer system including a display coupled to a positioning system and to a vector database, for forming an output display, the computer system comprising
a display manager coupled to the display for displaying an image of a particular geographic area on the display;
a raster database including images of a geographic area;
a raster map loader coupled to the raster database and to the display manager for retrieving the image of the particular geographic area from the raster database;
a distributor coupled to the positioning system for receiving vehicle data and to the vector database for receiving vector data;
an icon manager coupled to the display and to the distributor for determining icons and displaying the icons on the display in response to the vehicle data; and
a data manager coupled to the display and to the distributor for displaying vector data on the display.

2. The computer system of claim 1 further comprising:
a vector map database describing the geographical area; and
a vector map loader coupled to the vector map database for forming an image of another particular geographic area;
wherein the display manager is coupled to the vector map loader for displaying the image of the another particular geographic area on the display.

3. The computer system of claim 1 further comprising a vehicle data storage coupled to the data manager for storing vehicle data.

4. The computer system of claim 1 further comprising a landmark data storage coupled to the data manger for storing landmark data.

5. The computer system of claim 1 wherein the distributor is coupled to the display manager; and
wherein the display manager determines the particular geographic area.

6. The computer system of claim 1 wherein the distributor receives historical vehicle data and historical vector data from the positioning system.

7. The computer system of claim 1 wherein the particular geographic area is equal to the geographic area.

8. The computer system of claim 1 further comprising a callback manager coupled to the distributor for determining the particular geographic area in response to the vehicle data.

9. A computer system including a display coupled to a positioning system and to a vector database, for forming an output display, the computer system comprising:
a display manager coupled to the display for displaying an image of a particular geographic area on the display;
a raster database including images of a geographic area;
a raster map loader coupled to the raster database and to the display manager for retrieving the image of the particular geographic area from the raster database;
a vector map database describing the geographic area;
a vector map loader coupled to the vector map database and to the display manager for forming the image of the particular geographic area;
a distributor coupled to the vector database for receiving vector data, and to a positioning system for receiving the vehicle data;
an icon manager coupled to the display and to the distributor for displaying icons on the display in response to the vehicle data;
a data manager coupled to the display and to the distributor for displaying vector data on the display; and
a callback manager coupled to the display manager and to the distributor for determining the particular geographic area.

10. The computer system of claim 9 further comprising a landmark data storage coupled to the data manger for storing landmark data; and
wherein the callback manager determines the particular area in response to the landmark data.

11. The computer system of claim 9 further comprising a job data storage coupled to the data manger for storing job data; and
wherein the callback manager determines the particular area in response to the job data.

12. The computer system of claim 9 wherein the particular geographic area is smaller than the geographical area.

13. The computer system of claim 9 wherein the icons comprise a plurality of different icons; and
wherein the icon manager displays an icon from the plurality of different icons on the display.

14. The computer system of claim 9 wherein the callback manager is coupled to the icon manager for determining the icons to display.

15. The computer system of claim 14 wherein the callback manager determines icon shapes for the icons in response to the vehicle data.

16. A computer system including a display coupled to a dispatching system, to a positioning system, and to a geocoder, for forming an output display, the computer system comprising:
a display manager coupled to the display for displaying an image of a particular geographic area on the display;
a vector database describing a geographical area;
a vector map loader coupled to the vector database and to the display manager for forming the image of the particular geographic area;
a distributor coupled to the geocoder for receiving the vector data, to the positioning system for receiving the vehicle data; and
an icon manager coupled to the display and to the distributor for displaying icons on the display in response to the vehicle data;
a data manager coupled to the display and to the distributor for displaying vector data on the display; and
a callback manager coupled to the display manager and to the distributor for determining the particular geographic area.

17. The computer system of claim 16 wherein the data manager comprises a job data storage for storing job data.

18. The computer system of claim 17 wherein the distributor is coupled to the dispatching system for receiving job data.

19. The computer system of claim 16 wherein the callback manager is coupled to the icon manager for determining the icons to display on the display.

20. The computer system of claim 16 wherein the callback manager comprises a configuration data storage and is coupled to the icon manager for determining colors for the icons on the display.

21. The computer system of claim 16 wherein the callback manager comprises a configuration data storage and is coupled to the icon manager for determining shapes for the icons on the display.

22. A computer program product comprising:
a computer-readable media including:
code that retrieves an image of a particular geographic area from a raster database;
code that directs a display to display the image of a particular geographic area;
code that receives vehicle data;
code that receives vector data;
code that directs the display to display an icon in response to the vehicle data; and
code that directs the display to display the vector data.

23. A computer program product of claim 22, wherein the computer-readable media further comprises code that determines the particular geographic area.
